(19) United States
(12) Patent Application Publication
(10) Pub. No.: US 2017/0013343 A1
(43) Pub. Date: Jan. 12, 2017

(54) CABLE WINDING DEVICE

(71) Applicant: Arthur Leslie TOMLINSON, Buckhurst Hill Essex (GB)

(72) Inventor: Arthur Leslie TOMLINSON, Buckhurst Hill Essex (GB)

(21) Appl. No.: 15/119,666

(22) PCT Filed: Feb. 19, 2014
(86) PCT No.: PCT/GB2014/050490

§ 371 Date: Aug. 17, 2016

(51) Int. Cl. H04R 1/10; B65H 75/40; B65H 75/44

(52) U.S. Cl. CPC H04R 1/1033; B65H 75/4431; B65H 75/406; B65H 2701/34

(57) ABSTRACT

A winding device for a flexible cable. The device includes a housing and a cable winding spool rotatably mounted within the housing. An opening formed through the housing to allow a cable to be wound on the spool and a spring applies torque to the spool in a cable-winding sense. The spool has a cylindrical winding surface and a flange projects radially from the winding surface part-way between the axial ends thereof. A cable hook is formed in the flange, whereby a loop may be formed part-way between the ends of the cable and that loop may be passed through the opening to engage with the hook of the flange so that rotation of the spool under the action of the spring will wind the cable onto the spool, to both sides of the flange.

This invention relates to a cable winding device having a spool on which a flexible cable may be wound, for storage.

Many devices have cables to provide connection to an external power source or another device. Often, these cables are rather long, leading to parts of the cable being draped along the floor or worktop or simply hanging downwardly from the location of use. This is not only unsightly but is inconvenient for the user and may be dangerous. There is thus a need for an effective, fast and easy to use cable winding device.

This invention has been developed principally for the storage of headphone cables, and particularly for lightweight headphones of the kind commonly referred to as ear-bud headphones such as are very widely used with portable music players including mp3 players, mobile telephones and so on. The invention will hereinafter be described exclusively in relation to such headphone cables but it will be appreciated that the device may be used with cables of other electronic equipment such as a computer mouse or indeed with non-electronic cables, such as a dog lead. Further, depending upon the sizing of the cable winding device and the cable thickness and flexibility, the device may be used with other cables such as those associated with a radio or a television.

Headphones have a flexible electrical cable to carry the signal from a signal source to each of two ear units. Typically, a jack-plug is provided at one end of the cable and part-way along its length, the cable splits into two cable sections, there being a respective ear unit provided on the end of each cable section. When not in use, the headphone cable is typically wound around a few fingers of the user's hand and then is dropped in a small case, holder or bag, or perhaps just in a pocket of a user's clothing. Then, when the headphones are to be used once more almost invariably it is found that the cable has become entangled at least to some extent and must be untangled and stretched out before it may be used again.

Cable winding devices for use with earphone cables are known. Many of these devices incorporate cable winding mechanisms comprising multiple components which are difficult to assemble, often requiring the use of tools, and having loose parts. To draw a cable into the device it is usually necessary manually to wind the cable onto the mechanism, either directly or by way of a winding handle. This can be time consuming and quite often leads to the cables becoming tangled. Furthermore, many existing devices are designed for use with a specific type of earphone which is pre-installed during manufacture of the device and which cannot be removed easily from the device. These types of device are generally suitable only for a specific length of cable.

In order to address the above problem, there have been various proposals for cable winding devices arranged to hold a headphone cable wound around a spool rotatably mounted within a housing. For example, one such device is shown in my own earlier Patent Publication No. GB 2,469,302 but tests on that device have shown that it is possible for a cable to become entangled on the spool, in the course of winding the cable therearound or withdrawing the cable therefrom. This is a particular issue with a headphone cable which splits into two sections and especially if the cable is wound relatively loosely around the spool. Turns of the cable on the spool may cross over each other and then bind, when attempting to draw the cable from the spool. Furthermore, the attachment of the cable to such devices can be cumbersome and time consuming.

It is a principal aim of this invention to provide a cable winding device which is simple to assemble and use, and which minimises the likelihood of cable entanglement on the spool when the device is in use with a flexible cable.

According to this invention, there is provided a cable winding device for a cable of an electronic accessory, which device comprises a housing, a cable winding spool rotatably mounted within the housing, an opening formed through the housing to allow a cable to be wound on the spool, and a spring applying torque to the spool in a cable-winding sense. The device is characterised in that the spool has a cylindrical winding surface, a flange projecting radially from the winding surface part-way between the axial ends thereof, and a cable hook is formed in the flange, whereby a loop may be formed part-way between the ends of the cable and that loop may be passed through the opening to engage with the hook of the flange so that rotation of the spool under the action of the spring will wind the cable on to the spool, to both sides of the flange.

The term “cable” is used herein to mean any elongate, flexible material which is capable of being wound around the winding surface of the spool for storage. Such cables could include electronic cables such as audio headphones or earphones or non-electronic cables, for example ropes or leashes for retraining animals.

It will be appreciated that the flange on the winding surface of the spool maintains separate the two sections of the cable, to each side of the loop formed therein. Though there still may be overlapping turns in each section of the cable, depending upon the length of the cable to each side of the loop formed therein and the diameter of the cylindrical winding surface of the spool, in view of the much reduced length of cable (typically around one half) wound on each part of the spool, the likelihood of binding turns or other entanglement is greatly reduced. This is particularly so for a relatively lightweight highly flexible ear bud headphone cable, which otherwise is particularly prone to entanglement.

The cable hook preferably is defined by a slot formed in the flange and opening through the outer periphery thereof. In order to ensure a secure connection to the hook, the hook may lie at an angle to the true radial direction, or may have an inner part which lies other than at the true radial direction. For example, the slot may have a first part extending more or less radially and which opens into the periphery of the flange and a second part which extends at an obtuse angle to the first part, and so with a circumferential component. The loop in the cable is conveniently formed merely by bending the cable round into a U-shape, without the two sections of the cable thus formed overlapping. Then, by lightly gripping the cable in the region of the loop, that loop may relatively easily be inserted through the opening in the housing to engage the slot formed in the flange and which defines the cable hook.

There may be two but preferably four or even more essentially similar cable hooks formed in the flange equi-spaced around the periphery thereof, in order to ensure that at least one cable hook is readily accessible through the opening when a cable is to be wound on to the spool.

The housing may further comprise a separator adjacent the opening, the separator being configured to separate and guide the two parts of a looped cable engaged with the hook with one part to each side of the flange. The separator may include a pair of openings provided one each side of the flange for entry of the two parts of the cable into the opening in the housing. Additionally or alternatively, the separator may include a centrally disposed blade arranged to lie adjacent a periphery of the flange. The separator blade may have a slot into which a periphery of the flange is received in a non-engaging manner so as to permit rotation of the flange relative to the housing. Preferably, the separator projects radially outwardly from the housing with respect to the axis of the spool. This arrangement provides greater clearance both sides of the flange for entry of the parts of the cable. In this arrangement, the part of the housing adjacent the opening, opposed to the separator, may similarly project from the housing.

The arrangement of the housing, spool and spring should be such that pulling a wound cable off the spool charges the spring such that subsequently, when the cable is to be re-wound on to the spool, the spring may turn the spool in a cable-winding sense. For such an arrangement to operate as required, there must be a releasable restraining mechanism acting between the spool and the housing to resist rotation of the spool under the action of the spring, until released. Then, following the connection of a loop in the cable with one of the hooks of the flange, the restraining mechanism may be released to allow the spring to turn the spool and so wind the cable thereon.

In the event that the restraining mechanism is released when no cable is connected to the hook, the spool will rotate under the action of the spring in a cable-winding sense until the energy in the spring is discharged. The device cannot then be used to wind a cable until the spring has been re-charged manually, for example by inserting a finger through the opening in the housing and turning the spool against the action of the spring until sufficient energy has been stored, whereupon the restraining mechanism is operated or operates automatically, depending upon the design, to hold the spool with the spring charged, ready to receive a cable.

The flange may be configured like a cog, having a series of teeth therearound to facilitate charging of the spring. In this way, the teeth may partially extend from the opening so that rotation of the spool may be effected by running the device along a planar surface such that the teeth engage that surface. Alternatively, the outer periphery of the flange may have a knurled configuration so as to frictionally engage a surface.

In one possible form, the restraining mechanism comprises a ratchet arrangement for example having a series of notches or teeth provided on the spool and a peg, pawl or the like provided on the housing, interengageable with, but releasable from, the notches or teeth. A control for the peg or pawl maybe mounted on the housing and be accessible from outside the housing, to allow rotation of the spool, under the action of the spring, when required.

Yet another form of restraining mechanism may be configured for automatic operation to restrain rotation of the spool following partial or complete unwinding of the cable off the spool, by gently releasing the tension on the cable or by gently releasing the cable from the hook. When the cable is to be re-wound on the spool, then tension may once more be applied to that cable following engagement of the loop with the hook, but this time the tension is released suddenly (rather than gently) to allow automatic winding of the spool under the action of the spring. It would be possible to configure the restraining mechanism to operate in the opposite sense—that is to say, sudden release of tension restrains the spool against winding under the action of the spring and gentle release of tension allows the spool to turn under the action of the spring to wind the cable on to the spool.

The spring and spool are preferably configured such that the number of turns (or winds) of the spool directly corresponds to the length of the cable. In this way, the number of turns can be determined so that when winding the cable into the device, rotation of the spool can terminate before the cable ends are drawn into the device or before the cable ends (for example ear buds) prevent further rotation. For example an earphone cable having a total length of 1 metre, which will be reduced by 50% to 50 cm when looped may require three turns of the spool to wind fully thereon to prevent the ear buds being drawn into the housing, thus avoiding inadvertent stress on the cable ear buds.

It is preferred for the housing to define a cylindrical internal chamber within which the spool is rotatably mounted. The housing preferably fits closely to the axial ends of the spool to prevent the cable becoming jammed between the spool and the housing. The spring advantageously is a flat spiral-wound spring (sometimes referred to as a “clock-spring”) having a first end connected to the spool and a second end connected to the housing. The housing itself may include storage recesses for a jack-plug and ear bud headphone units, to protect those items from damage when the headphones are not in use.

Though the winding device of this invention is primarily intended for use with headphones which are themselves intended for use with an audio player such as an mp3 player or a radio, it would be possible to incorporate within the winding device of this invention such an mp3 player, radio or perhaps some other audio signal source. In this case, suitable electronic circuitry and a power source would have to be incorporated within the housing, as well as controls for that circuitry. The end of the headphone cable remote from the ear unit may be directly connected to the circuitry so obviating the need for the standard stereo jack-plug. Conversely, it would be possible to design the housing of a conventional mp3 player, radio or perhaps even a mobile telephone to incorporate a winding device of this invention.

In view of the above, this invention extends to a winding device of this invention in combination with an audio signal source incorporated within the same housing of the winding device and connected to a headphone cable with ear units on the distal end thereof. The headphone cable may then be wound around the spool in the same manner as has been described above when the headphone units are not being used but the cable may be extended from the spool to such an extent as may be required, when a user wishes to listen to the audio source.

By way of example only, one specific embodiment of winding device of this invention will now be described in detail, reference being made to the accompanying drawings in which:—

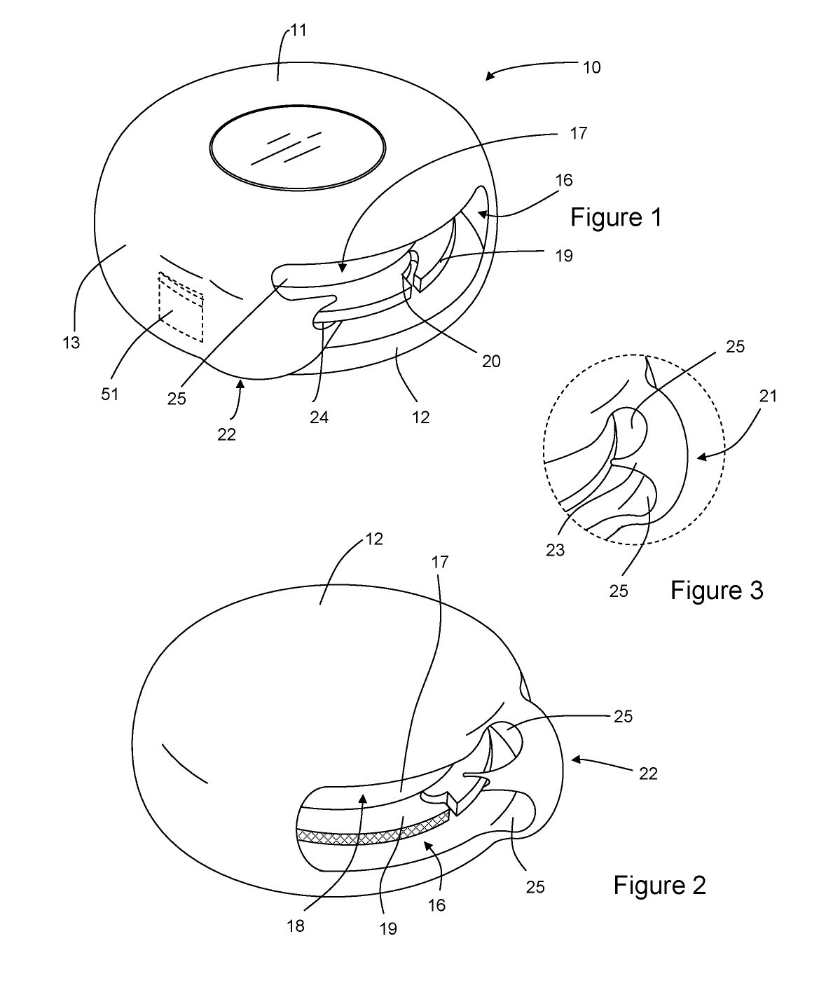

FIG. 1 is a general isometric view from above and one side of winding device of this invention;

FIG. 2 is a general isometric view similar to FIG. 1 but showing the other side of the device;

FIG. 3 is an alternative embodiment of housing cable separator;

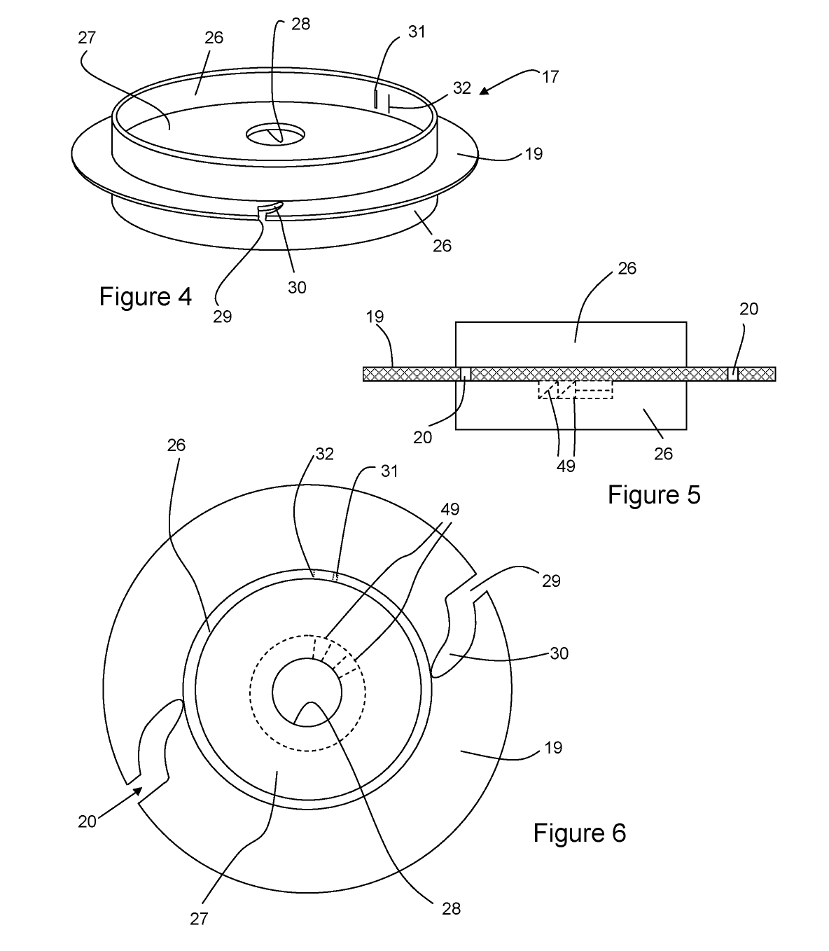

FIG. 4 is an isometric view of the cable winding spool employed in the embodiments of FIGS. 1 and 2;

FIG. 5 is a side view of the spool of FIG. 4;

FIG. 6 is a axial view of the spool of FIGS. 4 and 5;

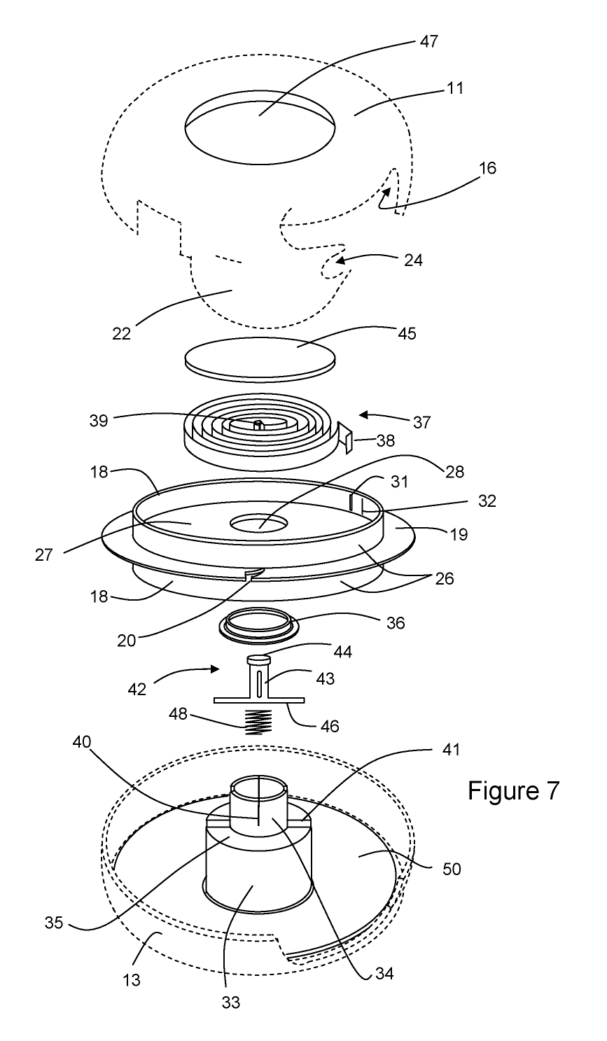

FIG. 7 is an exploded view of the device of FIGS. 1 and 2; and

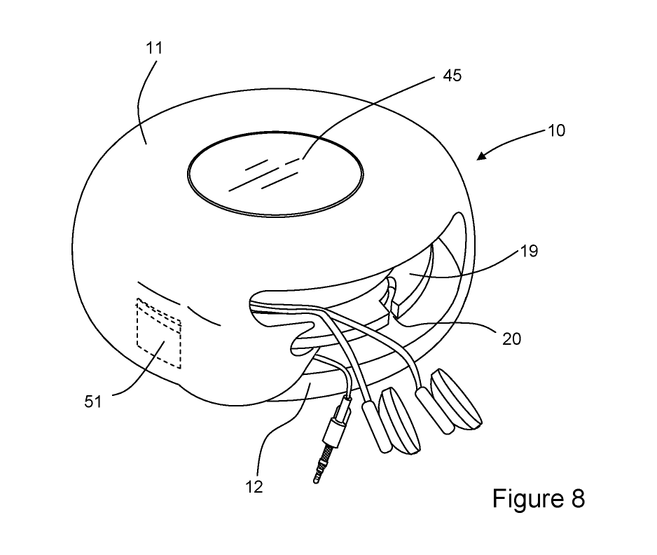

FIG. 8 shows the device of FIGS. 1 and 2 in use with a headphone cable, with the ear-bud units and jack-plug components lose.

As shown in FIGS. 1 and 2, the embodiment of cable winding device has a housing 10 of generally circular cross-sectional shape and having substantially planar upper and lower end faces 11, 12, conjoined by a rounded side wall 13. The side wall 13 may be integrally formed with the upper end face 11 and the lower end face 12 may be separately formed and then attached to the side wall 13, by an adhesive or otherwise snap-fitted thereto. Alternatively, the side wall 13 could be integral with the lower end face 12, or there could be a join-line part-way along the height of the side wall 13, with part integral with the lower end face 12 and the other part integral with the upper end face 11.

A rounded opening 16 is formed in the side wall 13, to allow access to a spool 17 rotatably mounted within the housing 10. That spool 17 has a cylindrical winding surface 18 with a flange 19 projecting radially outwardly from the winding surface 18, approximately mid-way between the axial ends thereof. The opening 16 may be configured such that the flange 19 extends partially out of the housing 10. Four hooks 20 are formed in the flange 19, equi-spaced therearound, but only one hook 20 is visible in FIGS. 1 to 3 and only two hooks 20 are shown in FIG. 5. Despite this, a practical embodiment of the winding device advantageously has four such hooks 20, in order that one of those hooks 20 is always readily accessible through the opening 16 in the housing 10. All or only part of the periphery of the flange may be knurled so as to assist with rotation of the spool 17.

A separator 21, 22 projects radially from the housing 10, adjacent the opening 16, and serves to separate and guide the two parts of a looped cable engaged with the hook 20, with one part to each side of the flange 19. Two embodiments of separator are shown in the diagrams. A first embodiment of separator 21 is shown in FIG. 3 and this includes a central blade 23 which is arranged to lie adjacent a periphery of the flange 19 in a very close relationship whilst being sufficiently spaced from the flange 19 so as to permit rotation thereof. FIGS. 1, 2 and 4 to 8 show a second embodiment of separator 22 also including a central blade 23 but which has a slot 24 formed therein into which a periphery of the flange 19 is received in a non-engaging manner. In both embodiments, the separator 21, 22 defines a pair of openings 25 one each side of the flange 19 to allow sufficient clearance either side of the flange 19 for entry of the cable into the opening 16 in the housing. This may assist in the control of the cable as it is drawn into the device as well as for dividing the cable.

Referring now to FIGS. 4 to 7, the internal arrangement of the winding device will now be described. The spool 17 has a cylindrical wall 26 around which the headphone cable is wound when the device is in use. Internally of that wall, there is a circular plate 27 extending in a radial plane and having a central circular aperture 28. The flange 19 is co-planar with that plate 27 and extends radially outwardly from the cylindrical wall 26. The plate 27 and flange 19 are disposed midway between the axial ends of the cylindrical wall 26, such that the winding surface 18 of the spool 17 to each side of the flange 19 have the same axial length.

As best seen in FIG. 6, the flange 19 has a pair of cable hooks 20, though as mentioned above four such hooks 20 may be equi-spaced around the flange 19. Each hook 20 has a first part 29 extending from the outer periphery of the flange 19 in a generally inward radial direction and a second part 30 which extends at an obtuse angle to the first part 29 so as to extend partially in a circumferential direction. A thin opening 31 and slot 32 are formed through the cylindrical wall 26 of the spool 17 for a purpose to be described below.

The lower housing part defining the lower end face 12 and side wall 13 includes an inwardly projecting hollow boss 33 having a hollow stub 34 of reduced diameter remote from the lower end face 12, with a shoulder 35 formed between the boss 33 and stub 34. The spool 17 is rotatably mounted on the stub 34 with an anti-friction washer 36 located on the stub 34 and bearing against the shoulder 35. A flat spirally-wound spring 37 has its outer end 38 extend into the thin opening 31 in the cylindrical wall 26 over the outer surface and hooked into the slot 32 and its inner end 39 hooked into a slit 40 in the stub 34. Rotation of the spool 17 in a counter-clockwise sense (in FIG. 6) tensions the flat spring 37. Once tensioned, the spool 17 must be restrained to prevent the spring 37 releasing its tension until a cable is to be wound on the spool 17. When released, the action of the spring 37 will turn the spool 17 in a clockwise sense.

A diametral slot 41 is formed in the stub 34 and extends into the boss 33 from the shoulder 35 towards the lower end face 12. Slidably mounted in the bore of the stub 34 and boss 33 is a release member 42 in the form of a shaft 43 having, at one end, a connector 44 arranged to secure to the underside of a release button 45 and, at the other (lower) end, a pair of opposed pegs 46. The pegs 46 locate in the slot 41 in the boss 33 when the housing is assembled, the button 45 then sits within a hole 47 formed in the upper end face 11 of the housing. The button 45 is recessed in the hole 47 to minimise accidental operation. A helical coil spring 48 is located in the hollow boss 33 and urges the release member 42 upwardly (in FIG. 7) and so towards the upper end face 11.

The underside of the plate 23 (in FIGS. 5 and 6) of the spool 17 is provided with a series of teeth 49 around the aperture 24, only two of which teeth 49 are shown diagrammatically in FIG. 6. Those teeth 49 are of saw-toothed profile and are engaged by the pegs 46 of the release member 42 to restrain rotation of the spool 17, until the button 45 is depressed against the action of the spring 48. This moves the release member 42 towards the lower end face 12 so that the pegs 46 come free of the teeth 49 and allow the spool 17 to rotate under the action of the flat spiral spring 37. Further to minimise tangling of the cable, a cylindrical annular plate washer 50 may be located between the lower housing part and the internal components and/or between the upper housing part and the internal components, the washer 50 being rotatable with respect to the spool 17.

In another embodiment (not shown), the size of the device could be reduced by enabling the upper and lower parts of the housing to connect to each other telescopically. In this arrangement movement of the parts towards each other can be used effectively to replace the function of the button and to wind the cable on to the spool.

To use the device, the flat spring 37 must first be charged, unless it is already under tension. Charging is achieved by a user pressing a finger inserted through the opening 16 on to the flange 19 and effect rotation of the spool 17 in a counter-clockwise sense, in FIGS. 1 and 6. In the course of this rotation, the pegs 46 automatically click over the teeth 49 of saw-tooth profile but the pegs 46 prevent rotation of the spool 17 in the opposite sense.

A window 51 may be provided adjacent the opening 16 or separator 21, 22 to enable the mechanics of the device to be seen or for part of the cable to project. The window 51 could be provided by a section of transparent material or simply an opening in the housing. More than one window may be provided around the side wall 13 of the device.

A headphone cable is wound on to the spool 17 by forming a simple U-shaped loop in the cable approximately half-way therealong and then connecting that loop to an exposed hook 20 of the flange 19 and accessible through the opening 16. Then, the release button 45 is depressed and the cable winds on to the spool 17, with one part of the cable to one side of the flange 19 and the other part of the cable to the other side of the flange. By maintaining separate the two parts of the cable in this way, the likelihood of binding turns on the spool 17 or otherwise cable jamming is greatly reduced. The user may of course control the re-winding by lightly gripping the cable.

When the headphones are to be used, the cable is pulled out of the opening, so rotating the spool 17 in the same sense as was done with a finger, inserted through the opening 16. The cable may be fully unwound and removed from the spool 17, or if more convenient at least some of the cable may be left on the spool. Re-winding of the cable is achieved by depressing the button 45 to release the spool 17, so long as tension remains in the spring 37 but if the tension has been lost for example by accidental depression of the button 45 when the cable was fully disconnected from the spool, the spring may be re-tensioned as has been described above.

FIG. 8 shows a headphone cable fully wound on the spool with the ear bud units and the jack-plug hanging freely from the ends of the respective cable parts.

1. A winding device for a flexible cable, the device comprising:
a housing;
a cable winding spool rotatably mounted within the housing;
an opening formed through the housing to allow a cable to be wound on the spool; and
a spring applying torque to the spool in a cable-winding sense;
wherein the spool has a cylindrical winding surface, a flange projecting radially from the winding surface part-way between the axial ends thereof, and a cable hook is formed in the flange, whereby a loop may be formed part-way between the ends of the cable and that loop may be passed through the opening to engage with the hook of the flange so that rotation of the spool under the action of the spring will wind the cable onto the spool, to both sides of the flange.

2. The winding device as claimed in claim 1, wherein the cable hook is defined by a slot formed in the flange and opening through the outer periphery of the flange thereof.

3. The winding device as claimed in claim 2, wherein the slot has a first part opening through the periphery of the flange and a second part extending at an obtuse angle to the first part from the radially-inner end thereof.

4. The winding device as claimed in claim 1, wherein there are two or more substantially similar cable hooks formed in the flange.

5. The winding device as claimed in claim 4, wherein the cable hooks are equi-spaced about the axis of rotation of the spool.

6. The winding device as claimed in claim 1, wherein the housing further comprises a separator adjacent the opening, the separator being configured to separate and guide the two parts of a looped cable engaged with the hook with one part to each side of the flange.

7. The winding device as claimed in claim 6, wherein the separator includes a pair of openings provided one each side of the flange for entry of the two parts of the cable into the opening in the housing.

8. The winding device as claimed in claim 6, wherein the separator includes a centrally disposed blade having a slot into which a periphery of the flange is received in a non-engaging manner.

9. The winding device as claimed in claim 6, wherein the separator projects radially outwardly from the housing with respect to the axis of the spool.

10. The winding device as claimed in claim 6, further comprising a releasable restraining mechanism acting to resist rotation of the spool under the action of the spring in a cable-winding sense.

11. The winding device as claimed in claim 10, wherein the restraining mechanism is a ratchet mechanism comprising a series of notches or teeth provided on the spool and a pawl or peg provided on the housing.

12. The winding device as claimed in claim 10, and further comprising a manually operable control mounted on the housing for effecting release of the restraining mechanism.

13. The winding device as claimed in claim 12, wherein the manually operable control includes a release button which when depressed with respect to the housing lifts the pawl or pegs out of engagement with the ratchet teeth or notches.

14. The winding device as claimed in claim 10, wherein the restraining mechanism is configured for automatic operation to restrain rotation of the spool following partial or complete unwinding of the cable off the spool, upon tension being applied to a cable engaged with the hook followed by release of the tension.

15. The winding device as claimed in claim 12, wherein the restraining mechanism is configured to allow automatic winding of the spool under the action of the spring following partial or complete unwinding of the cable off the spool.

16. The winding device as claimed in claim 1, wherein the housing defines a generally cylindrical internal chamber and the spool is rotatably mounted within the chamber.

17. The winding device as claimed in claim 1, wherein the spool has a central opening and is rotatably mounted on a shaft provided within the housing.

18. The winding device as claimed in claim 17, wherein the spring is spiral-wound and has a first end connected to the spool and a second end connected to the shaft.

19. The winding device as claimed in claim 1, wherein the spring is a flat spiral spring located within the spool.

20. The combination of the winding device according to claim 1, and an audio signal source incorporated within the same housing of the winding device and connected to a headphone cable with ear units on the distal end thereof.
